(19) United States
(12) Patent Application Publication
(10) Pub. No.: US 2022/0044192 A1
(43) Pub. Date: Feb. 10, 2022

(54) MANAGING AUTOMATED GUIDANCE AND VALIDATION OF STACKING ITEMS TO HANDLING UNITS

(71) Applicant: Transportation | Warehouse Optimization SaaS LLC, Franklin, TN (US)

(72) Inventors: Rafal P. Bielecki, Lukawiec Laka (PL); Ivan Konovalov, Cancun (MX); Thomas A. Moore, Franklin, TN (US)

(21) Appl. No.: 17/393,294

(22) Filed: Aug. 3, 2021

Related U.S. Application Data
(60) Provisional application No. 63/061,175, filed on Aug. 4, 2020.

(51) Int. Cl. G06Q 10/08

(52) U.S. Cl. CPC G06Q 10/087

(57) ABSTRACT

A method, system and/or computer usable program product for managing automated guidance and validation of stacking items including generating a predicted map of an item set stacked onto a handling unit; generating an observed map of the item set stacked onto the handling unit; and comparing the predicted map with the observed map to verify the position and orientation of the item set stacked onto the handling unit.

### PRIORITY CLAIM

This application claims priority to U.S. Provisional Application No. 63/061,175, filed Aug. 4, 2020, entitled “MANAGING AUTOMATED GUIDANCE AND VALIDATION OF STACKING ITEMS TO HANDLING UNITS”, the disclosure of which is incorporated in its entirety herein by reference.

### BACKGROUND

### Technical Field

The present invention relates generally to utilizing automated systems for stacking items, and more specifically to a computer implemented method for managing automated guidance for and validation of stacking items to handling units.

### Description of Related Art

Fulfilling orders quickly and efficiently from a warehouse onto handling units for shipping is an important part of the operation of many businesses and industries. It is through this process that items, such as products, may be shipped or otherwise provided for storage in a warehouse, then picked and stacked onto handling units for shipment.

Full automation of order fulfillment, including order selection, can be cost prohibitive. However, there is a need to increase productivity and drive greater efficiency throughout the process. For example, in a consumer products warehouse, to eliminate travel around the warehouse, it's desirable to select two or more customers' orders at the same time. This may significantly reduce time and effort for order selection, but mistakes are expensive. Even in a “goods to picker” environment, errors may be frequent and are generally increased with concurrent order selection of multiple orders at the same time due to the increased complexities involved.

### SUMMARY

The illustrative embodiments of the present invention provide a method, system, and/or computer usable program product for managing automated guidance and validation of stacking items including generating a predicted map of an item set stacked onto a handling unit; generating an observed map of the item set stacked onto the handling unit; and comparing the predicted map with the observed map to verify the position and orientation of the item set stacked onto the handling unit.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIG. 3 provides a perspective diagram of a powered pallet jack utilized by an order selector for stacking and transporting pallets, in which various embodiments of the present disclosure may be implemented.

FIG. 4 provides a high-level flow diagram of managing automated guidance and validation of stacking items to handling units, in which various embodiments of the present disclosure may be implemented;

FIGS. 5A-5C provide flow diagrams of managing automated guidance and validation of stacking items to handling units, in which various embodiments of the present disclosure may be implemented;

FIGS. 6A-6D provide an overhead view diagram of item stacking on handling units including validation of the stacking in accordance with a first embodiment of the present disclosure;

FIGS. 7A-7D provide an overhead and perspective view diagrams of item stacking on handling units including validation of the stacking in accordance with a second embodiment of the present disclosure; and

FIG. 8 provides a more detailed flow diagram of item stacking on handling units including validation of the stacking in which various embodiments may be implemented.

### DETAILED DESCRIPTION

Processes and devices may be implemented and utilized for managing automated guidance and validation of stacking items. These processes and apparatuses may be implemented and utilized as will be explained with reference to the various embodiments below.

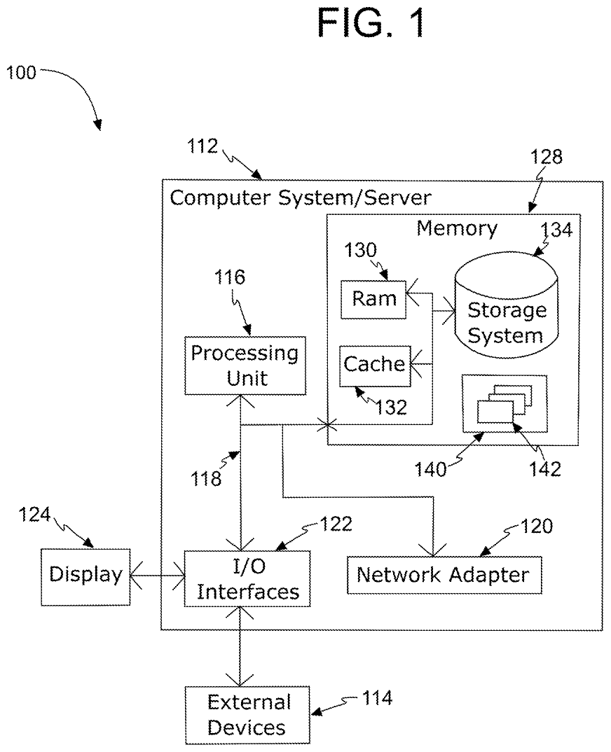

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as managing automated guidance and validation of stacking items.

In data processing system 100 there is a computer system/server 112, which is operational with numerous other computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices. For example, the present invention may be implemented in a cloud computing environment, distributed or otherwise, which may be virtualized such as with the use of a hypervisor managing multiple nodes including virtual processors, virtual memory, etc.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for managing automated guidance and validation of stacking items.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

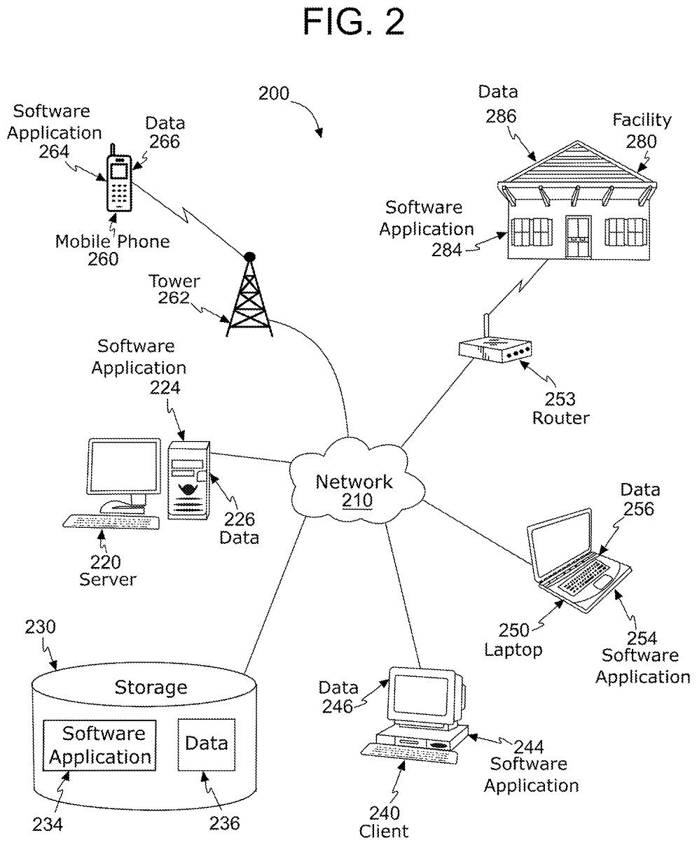

FIG. 2 provides a block diagram of an illustrative network of data processing systems in which various embodiments of the present disclosure may be implemented. Data processing environment 200 is a network of data processing systems such as described above with reference to FIG. 1. Software applications such as for managing automated guidance and validation of stacking items may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 are coupled to network 210 including wirelessly such as through a network router 253. A facility may be a home or business such as a warehouse or other structure with items stored in inventory for stacking, processing, loading and shipping to customers. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for managing automated guidance and validation of stacking items or other software applications and data in accordance with embodiments described herein. Storage 230 may contain software application 234 and a content source such as data 236 for managing automated guidance and validation of stacking items. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for managing automated guidance and validation of stacking items.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

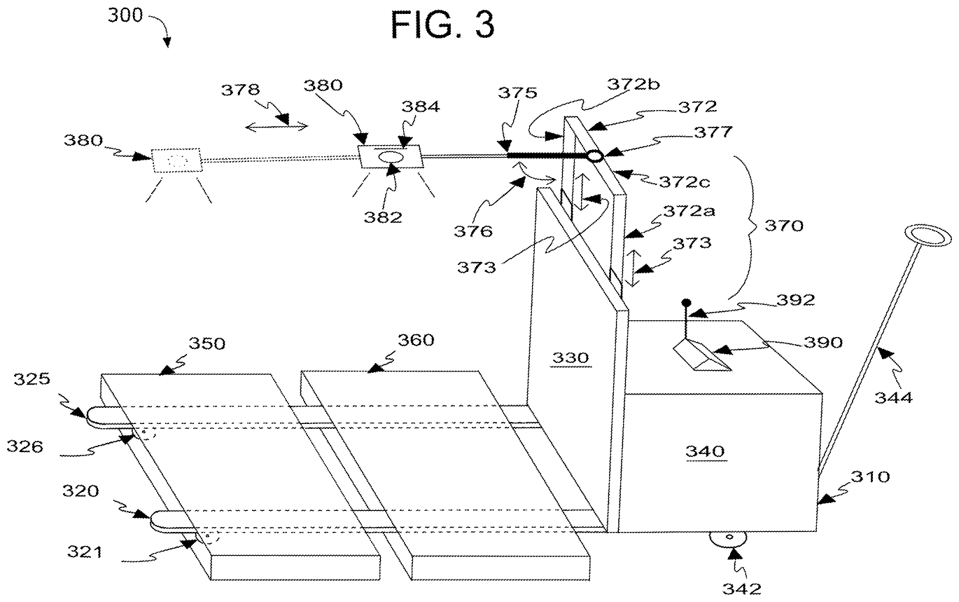

FIG. 3 provides a perspective diagram of a powered pallet jack utilized by an order selector for stacking, processing, loading and transporting pallets, in which various embodiments of the present disclosure may be implemented. A pallet jack 310 is an example of a type of material handling equipment (MHE) utilized by an order selector to utilizing for stacking, holding and transporting one or more handling units. Other types of material handling equipment include a forklift, an un-powered pallet jack; a platform truck, a pallet dolly, an automatic guided vehicle, a Kiva type robot, etc. A pallet is an example of a cargo carrier, which when stacked with items is collectively herein referred to as a handling unit. Other types of cargo carriers/handling units include platforms and containers. Examples of a platform include a slip-sheet, skip, etc. Examples of a container include a barrel, crate, etc. Although the present embodiment is directed to an order selector stacking and transporting items on pallets held by a pallet jack, other types of MHEs and cargo carriers/handling units may be utilized.

Pallet jack 310 includes left and right forks or tines 320 and 325, left and right front wheels 321 and 326, guard 330, and main body 340 with rear wheel 342 and steering and control mechanism 344. Two pallets 350 and 360 are shown being held and transported by pallet jack 310 on forks 320 and 325. More or fewer pallets may be held and transported in alternative embodiments.

Pallet jack 310 also includes sensing and projecting assembly 370. Sensing and projecting assembly 370 includes a guard extender 372 including a left arm 372a, a right arm 372b, and a cross member 372C. Guard extender 372 may be projected upwards or retracted downwards 373 manually, through the use of hydraulic pistons, electric motor(s), etc. Sensing and projecting assembly 370 also includes an arm 375 including a sensing and projecting unit 380. Arm 375 may be swung out or in 376 to a roughly horizontal or vertical position at pivot point 377, such as by an electric motor. Arm 375 may also be extended 378 outwards over pallet 350 or retracted backwards over pallet 360 through the use of a hydraulic piston, electric motor, etc. The entire sensing and projecting assembly 370 may be safely retracted and stowed predominately behind guard 330 by retracting arm 375, swinging arm 375 to a roughly vertical position, and retracting guard extender 372. This retracting and stowing of sensing and projecting assembly 370 may occur prior to pallet jack 310 moving from one location to another so as to protect assembly 370 from damage during such movement. Sensing and projecting unit 380 includes a detection device 382, such as a camera, and may include a light or projector 384 such as a laser projector. Detection device 380 may also include a microphone and speaker for communicating with the order selector. Detection device 382 may be utilized for sensing the stacking of items on pallets 350 and 360 as described in greater detail below. Light projector 384 may be utilized for indicating where the item should be stacked by the order selector onto pallets 350 and 360.

Also shown on pallet jack 390 is a communication device 390 including antenna 392. Communication device 390 may communicate with a central server or other system regarding the movement of pallet jack 310 and the stacking of pallets 350 and 360 such as described in greater detail below. Communication device may also communicate with various other devices in the facility such as bar code scanners, RFID tags, locator beacons, etc. for determining a location of pallet jack 310. Determining the location of pallet jack 310 may have multiple uses, such as determining whether the pallet jack is in the correct location for picking and stacking the next item on the pallet. Communication device may also communicate with the order selector verbally, visually or otherwise regarding the movement of the pallet jack and the stacking of pallets 350 and 360. Communication device may also communicate with sensing and projecting unit 380 as well as various other devices that may be worn (e.g., augmented virtual headset) or held by the order selector for guiding the order selector and validating that the pallets have been correctly stacked such as described below.

Many other alternative sensing and projecting assembles may be utilized for the present invention. For example, the arm assembly may be fixed in place with two or more cameras, one over each pallet, assuming that it does not need to be retracted and safely stowed such as when the pallet jack is being moved. For another example, the arm assemble may include a scissor lift and/or arm extension assembly as well as other types of assemblies. In addition, multiple cameras and projectors may be utilized such as to provide stereoscopic vision. A speaker and microphone may also be included in sensing and projecting unit 380 for communicating with the order selector. Alternative embodiments may also utilize the order selector wearing an augmented reality visor or headset in lieu of a projector, speaker and microphone on the arm assembly.

As will be explained in greater detail below, sensing and projecting assembly 370 is utilized to assist the order selector in stacking items on pallets 350 and 360, including guiding the order selector where to stack selected items on each pallet and validating whether the appropriate items were stacked onto the correct pallet in the correct position and orientation.

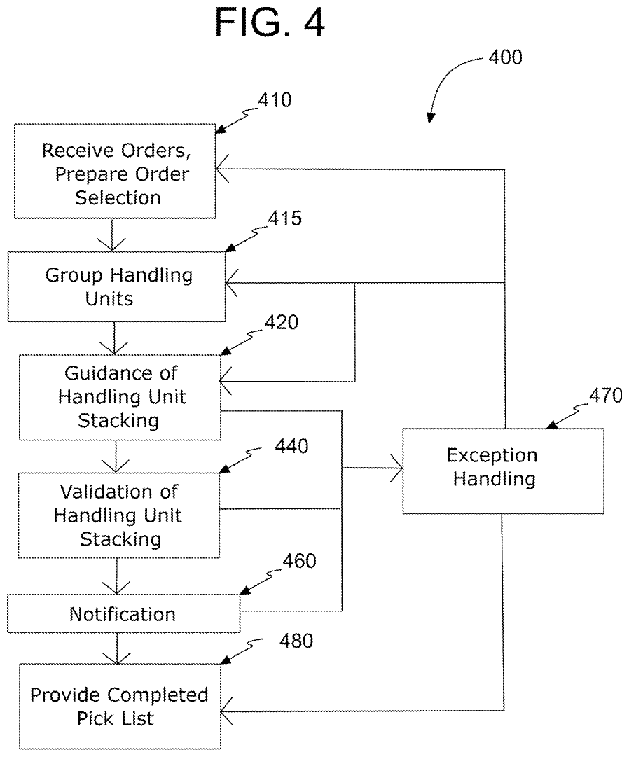

FIG. 4 provides a high-level flow diagram 400 of managing automated guidance and validation of stacking items to handling units, in which various embodiments of the present disclosure may be implemented. This flow diagram is explained with reference to the embodiment shown in FIG. 3, but the flow diagram can apply to other types of MHEs, sensing and projector assemblies, and cargo carriers/handling units.

In step 410 one or more orders, from one or more customers, is received requesting items for shipment. These orders may be received over a period of time such as a few hours, a day, a few days or a week. This set of orders may then be combined and utilized to identify a set of shipments to fulfill these orders. Each shipment includes a set of handling units, each handling unit stacked with ordered items. Typically each handling unit includes items from a single order or from multiple orders from a single customer or multiple orders from multiple customers, depending on transportation constraints or customer requirements. These transportation constraints or customer requirements may be provided with the order(s) and/or may be stored in memory associated with each transportation type carrier or vehicle location or customer location.

A set of handling unit stacking rules and a set of shipment loading rules may be applied to determine how each handling unit is stacked and how the handling units are then loaded onto a shipment. For example, each handling unit may have certain weight, size, weight distribution, and other rules as well as the shipment may have certain weight, size, weight distribution and other rules for stacking handling units within a given shipment. These handling unit stacking rules and these shipment loading rules may vary based on the type of handling unit and the type of transportation unit for a given shipment. In addition to these handling unit and shipment loading rules, each item may have certain packing rules based on the characteristics of that item. For example, each item may have certain crushability characteristics that may limit the weight of items stacked above that item in a given handling unit.

At the end of this step 410, each handling unit is associated with an item selection list and stacking instructions prepared for stacking the ordered items to a cargo carrier. As mentioned above, a cargo carrier, such as a pallet, that is stacked with ordered items is collectively referred to herein as a handling unit. The generated item selection list and the stacking instructions are collectively referred to herein as an order selection.

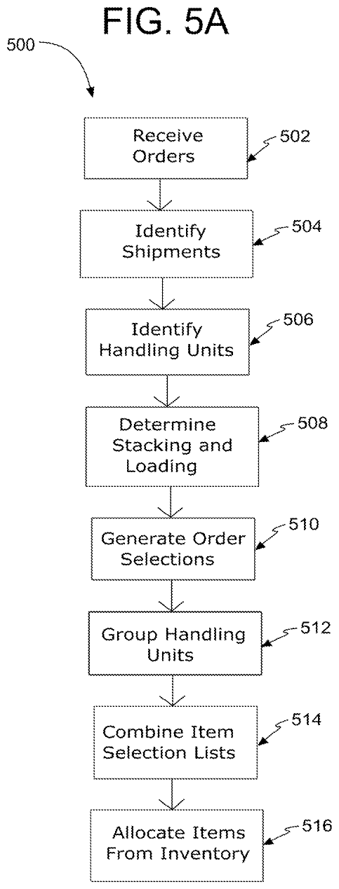

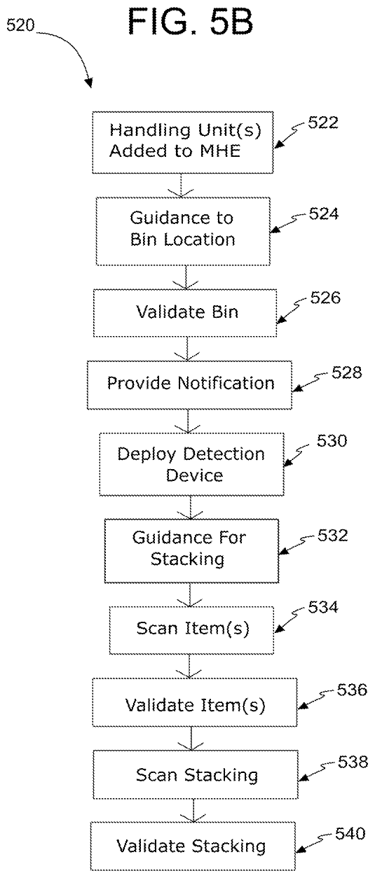

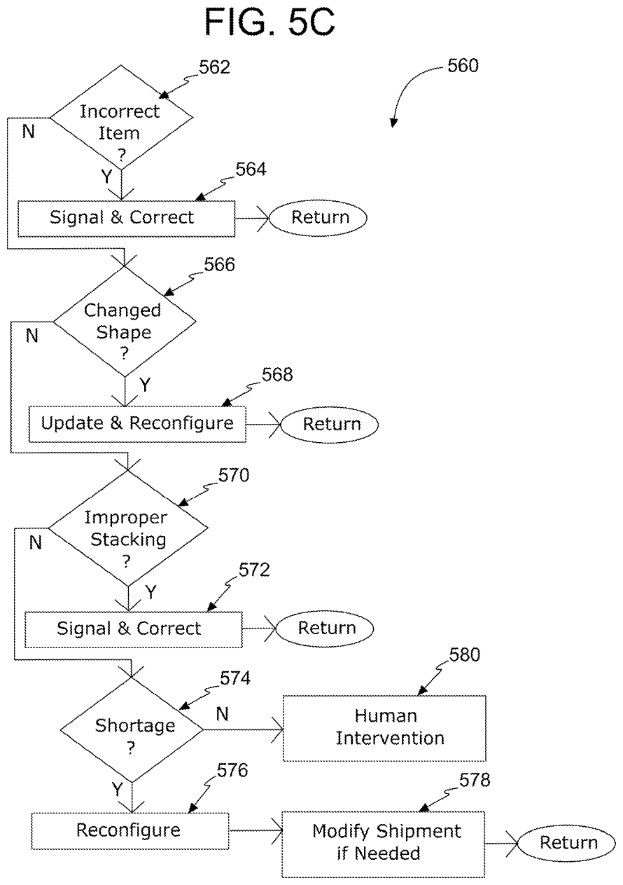

Then in step 415, handling units may be grouped together for concurrent picking and stacking. That is, such as shown with reference to FIG. 3 above, multiple handling units may have items picked and stacked by an order selector concurrently. Handling units may be grouped for concurrent picking and stacking based on reducing travel distance or other characteristics that reduce the travel distance, effort and the time needed for picking and stacking items onto the grouped handling units concurrently. For example, two handling units may include many of the same items for picking, which improves picking and stacking efficiency. The two handling units may or may not be for the same shipment. With grouped handling units for concurrent picking, the associated order selection lists for each handling unit may be combined into a single order selection list. Such a combined list may include clear indications which pallet to stack each picked item, although alternative indicators, such as described herein, may be utilized for indicating to the order selector which handling unit to stack each item. In step 415, a single order selection list may be generated for multiple handling units to have items picked and stacked concurrently without the generation of separate order selection lists for each handling unit. Steps 410 and 415 are described in greater detail below with reference to FIG. 5A.

Then in step 420, pursuant to one or more order selections, the order selector may be guided to pick and stack items from various locations in inventory to the handling units in accordance with the order selection. This may include guiding the order selector to travel to various inventory locations in a facility for picking the items identified in the item selection list and guiding the order selector to stack the picked items to the handling units in accordance with the stacking instructions. Alternatively, the items identified in the item selection list may be automatically provided to the order selector mechanically, such as by conveyor belts, automatic guided vehicles (AGVs) or robots. The order selector may be guided to stack the mechanically provided items to the handling units in accordance with the stacking instructions. In either case, this stacking guidance includes automatically guiding the order selector to stack a specified number of the items identified in the item selection list in a defined position and orientation to the handling units. This guidance may be performed, such as shown with reference to FIG. 3, through the use of projecting and communication equipment situated on a MHE utilized for holding and transporting handling units for stacking.

In step 440 an automated validation is performed of the type of item stacked, the number of items stacked, and of the position and orientation of the items stacked to the handling units. This validation may be performed, such as shown with reference to FIG. 3, through the use of video, scanning, and communication equipment situated on a MHE or with an order selector. Based on this automated validation, in step 460 a notification of the validation or lack thereof is automatically provided to the order selector or other persons through several types of communication such as visual cues, textually, auditory cues or instructions, etc.

In step 470, exception handling may be utilized to manage certain exceptions to the above described process. For example, an item may be missing from inventory or an insufficient number of a given item may be available from inventory. Discovery of these types of shortages may occur during the order selection process. In case of such shortages, items may need to be stacked differently for a given handling unit, items for stacking may be shifted from one handling unit to another, and shipments may need to be modified to adjust to these types of changes. In general, it is preferable to not re-stack items that have been picked already.

Finally, upon completion of the order selection, in step 480 a completed item selection list is automatically provided including any notifications of missing items and the stacked items are processed (e.g., stretch wrapped and/or strapped) and provided for shipping or otherwise processed and provided as requested. Steps 420, 440, 460 and 470 as well as the sub-steps contained therein may be performed in a circular or other non-linear fashion depending on the circumstances such as described below. The other steps and sub-steps described herein may also be performed in a non-linear fashion as well.

FIGS. 5A-5C provide flow diagrams of managing automated guidance and validation of stacking items to handling units, in which various embodiments of the present disclosure may be implemented. These flow diagrams are explained with reference to the embodiment shown in FIG. 4, but in greater detail. These flow diagrams are also explained with reference to the embodiment shown in FIG. 3, but the flow diagram can apply to other types of shipping loading determinations, handling unit stacking determinations, MHEs, sensing and projector assemblies, and cargo carriers/handling units.

FIG. 5A is a flow diagram 500 directed to processes for progressing from receiving a set of orders to generating order selections, the order selections used for stacking ordered items on handling units which are processed and loaded onto shipments to fulfill the received orders, such as described above with reference to steps 410 and 415 of FIG. 4. Steps 502-516 may be processed automatically by one or more special purpose computers programmed for this purpose.

In step 502, a set of orders for are received identifying items and quantities to be shipped to a certain locations by a certain time. This set of orders may be received from one or more external or internal customers requesting items, such a tangible goods, to be stacked, packaged, loaded and shipped in accordance with the set of orders. These orders may be received over a period of time such as a few hours, a day, a few days or a week. These orders may be received on-line, such as through automated ordering systems, or may be manually received such as by phone and then entered on-line by those talking the phone orders.

Then in step 504, this set of orders may then be combined and utilized to automatically identify one or more shipments to fulfill these orders. This set of shipments may be forward looking over an extended period of time (e.g., the next couple of weeks) and then adjusted as shipment day approaches based on new orders, modifications to existing orders, changes in transportation types and numbers available, etc. Each shipment may be transported by a truck, a railroad car, a ship, etc. such as a truck trailer, a cargo container, or other type of transportation for transporting and delivering the shipment. Each shipment includes a set of handling units, each handling unit stacked with ordered items. Typically each handling unit includes items from a single order or from multiple orders from a single customer, depending on a customer'(s) stacking and loading requirements. These customer stacking and loading requirements may be provided with the order(s) and/or may be standing customer requirements stored in central memory associated with each customer.

Several techniques may be used to identify these shipments including transportation capabilities and associated constraints for each transportation type, as well as customer requirements associated with each customer, customer shipment, or customer order. For example, a set of customer orders may require the delivery of certain items from one location such as a warehouse (i.e., node A) to another location such as a customer facility (i.e., node D), as well as any locations such as other customer facilities roughly located there-between (i.e., nodes B and C). That is, a shipment may be scheduled with a transportation type such as a large truck which can ship the items on handling units from node A to nodes B, C and D within the capacities and constraints of the transportation type while meeting customer requirements. The transportation type capacities and constraints may be obtained from central memory.

Another factor for determining shipments includes calculating the forecasted number of handling units to be shipped between or among various locations. This forecasted number of handling units to fulfill each order may be determined based on a predicted weight and volume of that order which is based on the weight and volume of the items and quantities ordered. Such shipment determinations may be approximations and may be modified upon further processing as described below.

In step 506, a set of handling units for loading onto each shipment is more precisely defined or otherwise identified automatically, each handling unit to include a set of items to be stacked precisely in preparation for shipping those items in accordance with the set of orders. This step may be performed only on shipments about to occur in the near future (e.g., the next couple of days) as compared to step 504. The set of handling units for loading onto each shipment may be more precisely defined based on known or projected available inventory. That is, inventory management software may maintain an ongoing database of items stored in a warehouse or other storage facility, the database updated based on a variety of inputs. The database inputs can include picking of items by order selectors, identified shortages by these order selectors, periodic physical inventory audits, etc.

Then in step 508, a set of handling unit stacking rules, a set of shipment loading rules, a set of item packing rules, and the location or relative location of each item to be stacked to a handling unit are factors which may be automatically applied to determine how each handling unit defined in step 506 is stacked and how the handling units are then loaded onto a shipment. For example, each handling unit may have certain weight, size, weight distribution, and other rules as factors for consideration. In addition, the shipment may have certain weight, size, weight distribution and other rules as factors for consideration for stacking handling units within a given shipment. These handling unit stacking rules and these shipment loading rules may vary based on the type of handling unit and the type of transportation unit for a given shipment. These factors for consideration can include a limited total weight of a fully stacked handling unit, a limited total height, width and length of a stacked handling unit, a balance of the weight of the various items stacked to the handling unit so that it is not top heavy, overly weighted to one side or over one trailer axle, etc. Other factors can include the use of a flat top above a handling unit so that it can sustain the weight of another handling unit without risk of damage to items on the underlying handling unit. In addition to these handling unit and shipment loading rules, each item may have certain packing rules based on the characteristics of that item such as crushability factors of the various items to be stacked, various hazardous combinations of items (e.g., bleach and ammonia), etc. For use in applying these item packing rules, handling unit stacking rules, and shipment loading rules, a record of each item's characteristics may be maintained in an item characteristics database including the item's dimensions, weight, crushability, hazardous considerations, etc. For example, each item may have certain crushability characteristics that may limit the weight of items stacked above that item in a given handling unit (e.g., to avoid stacking heavy water bottles on top of eggs). Furthermore, items to be stacked to a handling unit are located throughout a facility and the distance between various items may be another set of factors taken into consideration when determining how to stack these items and the sequence of their stacking to a handling unit. When there is a conflict between the stacking rules, the packing rules and the distance between items, user-defined weights to mathematically trade-off calculated rewards and punishments to determine the relative applicability of these conflicting requirements and the resulting course of action. Alternatively, the stacking rules and packing rules may take priority unless the stacking rules or packing rules indicate otherwise.

In step 510, an order selection list and associated stacking instructions are generated based on the application of the item characteristics, item packing rules, handling unit stacking rules, shipment loading rules, and the location or relative location of each item to be stacked as described in step 508. The order selection may include the item selection list and stacking instructions suitable for computer utilization. The item selection list may be sequenced according to the chronology or travel path that the items should be stacked for efficiency. The stacking instructions may include a specific position and orientation of each item for a given handling unit so as to meet the stacking factors and rules. In the present embodiment, an item selection list is a list of items and a quantity thereof utilized for directing an order selector to select the listed items from inventory for loading to a handling unit. The corresponding stacking instructions direct the order selector to stack the listed and selected items onto the handling unit in a desired position and orientation in accordance with a set of stacking rules. Item selection lists and stacking instructions may be combined for multiple handling units as described below. An order selector may be a machine, a robot, a person or persons selecting and stacking the listed items in accordance with the item selection list and the corresponding stacking instructions.

In many applications, a given handling unit is stacked with items from a single customer. However, an order selector may be able to stack multiple handling units concurrently such as illustrated in FIG. 3. In the present embodiment, the multiple handling units being stacked concurrently may be fulfilling orders from multiple customers. For example, an order selector may be stacking two handling units concurrently, the first handling unit being stacked with items ordered by a first customer and the second handling unit being stacked with items ordered by a second customer. In such a case, the order selector needs to be very careful to properly segregate the ordered items by customer and handling unit to avoid shipping any of those items to the incorrect customer.

In step 512, handling units may be grouped together for concurrent picking and stacking. That is, multiple handling units may have items picked and stacked by an order selector concurrently, possibly each handling unit being stacked for different customers. Handling units may be grouped for concurrent picking and stacking based on reducing travel distance or other characteristics that reduce the time needed for picking and stacking items onto the grouped handling units concurrently. For example, two handling units may include many of the same items for picking, which improves picking and stacking efficiency. For another example, two handling units may include items for picking that are close to each other, which also improves picking and stacking efficiency.

In step 514, a combined item selection list for the grouped handling units may be generated from the item selection list(s) generated in step 508 above. The combined item selection list may be generated from each item selection list associated with each of the grouped handling units, but combined for efficient concurrent picking for the grouped handling units. That is, the sequence of the combined picking of items is provided for efficiency such that items are picked in a sequence for reducing travel distance and improved efficiency for concurrent picking for all the grouped handling units. Such a combined list may include clear indications which pallet to stack each picked item, although alternative indicators, such as described herein, may be utilized for indicating to the order selector which handling unit to stack each item. In alternative embodiment, steps 508 through 512 may be combined into a single step such that a single order selection list may be generated for multiple handling units to have items picked and stacked concurrently without the generation of separate order selection lists for each handling unit.

In the present embodiment, while the item selection lists for each of the grouped handling units may be combined, the associated stacking instructions for each handling unit may not be combined. Rather, the previously determined stacking instructions for each handling unit may be utilized for that handling unit as it is stacked with items.

Then in step 516, the items to be picked for the grouped handling units may be allocated for such picking so that those items and quantities thereof are not picked or otherwise removed from inventory by others. That is, the inventory needed for fulfilling the combined picking of items for the grouped handling units are allocated for such picking and should not be picked or otherwise removed from inventory prior to such combined picking. Step 516 may be performed at any time during this process or not at all (alternative embodiments may not include this step), such as when the handling units are identified in step 506 above, but for completeness it is included here. Processing may then continue to the steps described below with reference to FIG. 5B.

FIG. 5B is a flow diagram 520 directed to processes for picking and stacking items onto a set of handling units pursuant to an order selection, such as described above with reference to steps 420 through 460 of FIG. 4. In this description of the present embodiment, an item may be one or more tangible goods stored in inventory for selection (AKA picking) and stacking as part of a handling unit. The handling unit may be packaged and shipped with the selected items. An item selection list may also be referred to as a pick list herein. An order selector may also be referred to as an order picker herein. A handling unit may include a cargo carrier, such as a container or a platform, for holding items for shipment and may be moved by a MHE such as a forklift, pallet jack, by hand, etc. A container may be referred to as a crate if it is essentially a wooden box. A platform may be a referred to as a pallet or skid if designed to be handled by a forklift. Once a handling unit has been stacked with items for shipping or otherwise for providing to a customer, the handling unit may be processed for shipping such as by stretch or shrink wrapping or strapping. A stacked and processed handling unit may be referred to herein as a shipping unit. A shipment may include multiple shipping units fulfilling one or more customer orders. The shipping units may be loaded onto a truck or other transportation vehicle in accordance with certain shipping rules.

The following steps of the present embodiment assume that the order selector is obtaining items from multiple bins located throughout a facility holding inventoried items in those bins. The order selector may be driving or otherwise directing a forklift, pallet jack, or other type of material handling equipment (referred to herein as MHE) for holding and transporting handling units. An example of a pair of pallets is shown in FIG. 3 as described above. Alternatively, the order selector may be in a specific location within the facility and the items provided to the order selector automatically such as by conveyor belts or robots. The order selector may receive instructions or other type of input through a written report, a text or other information displayed on a display screen mounted on the MHE, on a handheld mobile device, or on a virtual reality headset, audibly through speakers either mounted on the MHE, through the handheld mobile device or virtual reality headset, or through a variety of other devices which may be useful for communicating clearly with the order selector.

In step 522, an order selector adds a set of cargo carriers (i.e., unstacked handling units) to a MHE for stacking ordered items onto the cargo carriers pursuant to one or more order selections. In some cases, a cargo carrier may already be partially stacked with items. Then in step 524, the order selector may be guided to pick and stack items from various locations in inventory to the handling units in accordance with the order selection list(s). This may include guiding the order selector to travel to various inventory locations such as bins in a facility for picking the items identified in the item selection list. This could be as simple as providing a bin address (e.g., Aisle X, Bay Y, Level 1) within a facility holding inventory for picking. Alternatively, the order selector may be provided a route map or other directions to the bin location using live streaming communication devices. In an alternative embodiment, the items identified in the item selection list may be automatically provided to the order selector mechanically, such as by conveyor belts or robots.

Once the order selector has reached the bin as guided, the location and product contained therein may be validated in step 526. This may be by verifying RFID signals from RFID devices located at the nearest bins, by use of GPS (global positioning system), a detection device such as a camera on the MHE that reads a label placed by the bin, bar-code scan, or other automatic locating systems. If the order selector is at an incorrect location or product, the order selector may be notified of this event in step 528, and the order selector is instructed to proceed to the correct bin location or warned that the wrong product is located there. If the order selector is unable to find the correct bin or if the correct bin or items are not available, then processing may proceed to exception handling such as described with reference to FIG. 5C below. If the order selector is at the correct location and has the correct product, the order selector may either be notified of this event or no notification is provided.

In step 530, a camera and projecting equipment may be deployed above the handling unit to be stacked with items from the nearby bin, such as shown in FIG. 3. Then in step 532, the order selector may be guided to stack the picked items to the handling units in accordance with the stacking instructions. This includes providing identification information regarding the item to be picked and stacked as well as including a quantity of that item to be picked. This stacking guidance includes automatically guiding the order selector to stack a specified number of the items identified in the item selection list in a defined position and orientation to the handling units. This guidance may be performed visually through the use of augmented reality glasses, visualization equipment situated on a user headset or elsewhere, or projecting equipment situated on a MHE utilized for holding and transporting handling units for stacking, such as shown with reference to FIG. 3. For example, a laser or bright light, mounted as projecting equipment on the MHE, may light up where the item(s) are to be placed on the appropriate handling unit. This information may also be provided to the order selector through a virtual reality headset worn by the order selector or on screens located on the MHE.

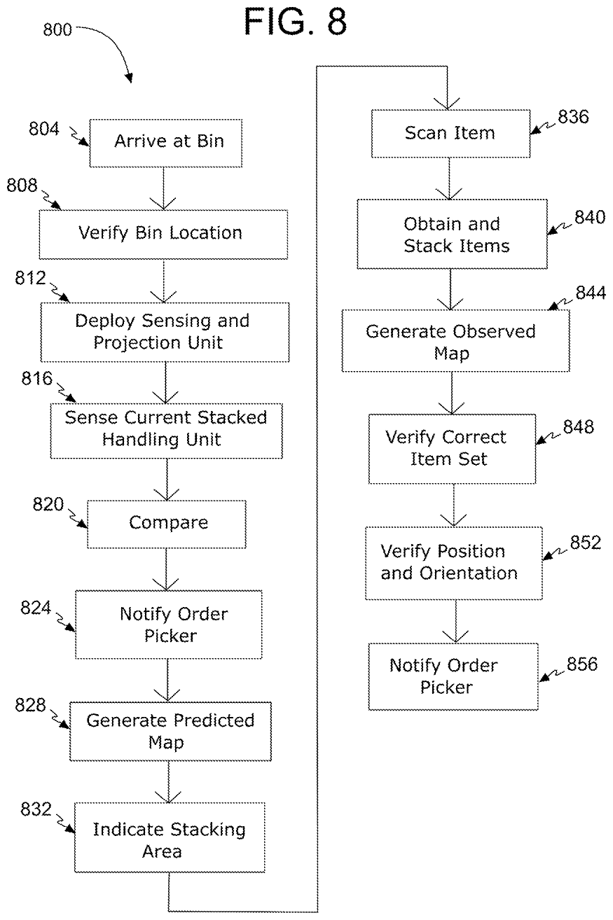

In step 534, as the order selector starts to select items from the validated bin, the order selector may scan the item or items being picked. This may be accomplished through the use of a hand scanner. Alternatively, the order selector may verbally state the items being selected such as a general description or by calling out an item code printed on or tagged to the item being picked. This verbal statement may be picked up by a microphone worn by the order selector or located on the MHE such as with the deployed detection device. Additionally, the detection device mounted on the MHE scans the item being picked for valid dimensions and may scan the item for any identifying marks and/or for the dimensions of the item. Once the item has been scanned, it may be validated in step 536. If validated, then the order selector may be notified that the correct item has been picked for stacking onto the handling unit. In an alternative embodiment, which may be implemented in combination with the other validation options identified herein, a camera or other type of detection unit may observe the picker and/or the picker's hands to determine whether the picker is picking from the correct bin. For example, if the picker is observed to be standing in front of the correct bin picking items, slightly to the left of the correct bin and reaching to the right to pick items, slightly to the right of the correct bin and reaching left to pick items, or standing in front to the correct bin with hands hidden because of the body of the picker blocks the view of the pickers hands (i.e., the picker is reaching forward into the correct bin), then the picker is assumed to be picking from the correct bin. If not, then the picker may be instructed to scan the items being picked to verify that they are the correct items or other corrective or validation actions such as described below with reference to FIG. 5C. In a second alternative embodiment, which may be implemented in combination with the other validation options identified herein, a camera or other type of detection unit may take images of the correct bin before and after the items are picked from that bin. The before and after images may be compared to determine whether the picker picked from the correct bin and whether the correct number of items were picked. If not, then the picker may be instructed to scan the items being picked to verify that they are the correct items or number of items or other corrective and validation actions such as described below with reference to FIG. 5C. This second alternative embodiment may utilize the mapping techniques described below with reference to FIG. 8. In each alternative embodiment, the camera or other scanner may utilize the camera or other detection unit installed on the MHE for identifying the bin bar code or for verifying stacking of the items onto the handling unit. Alternatively, another camera or detection unit may be installed on the MHE or near the bin area for performing this validation. If an incorrect item has apparently been picked, then an exception has occurred. The order selector may be notified that the correct or incorrect item has been picked and may be instructed to pick the correct item or take other corrective actions taken through the process described with reference to FIG. 5C below.

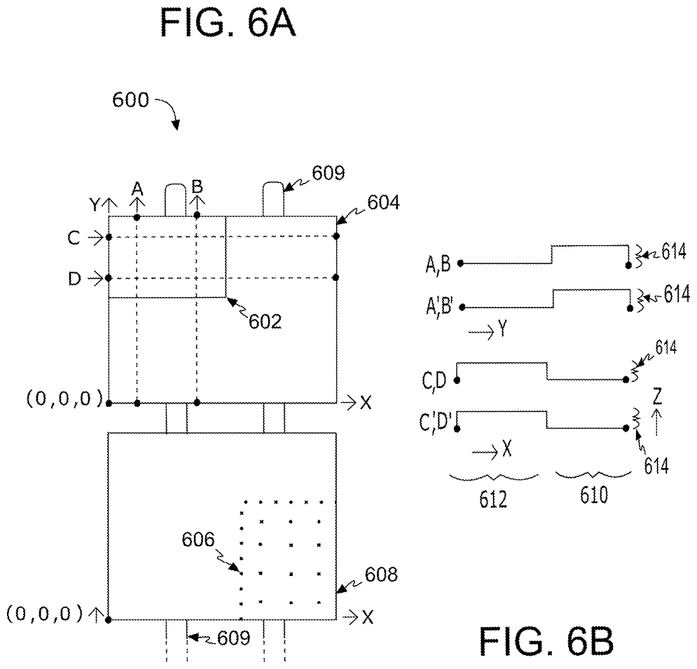

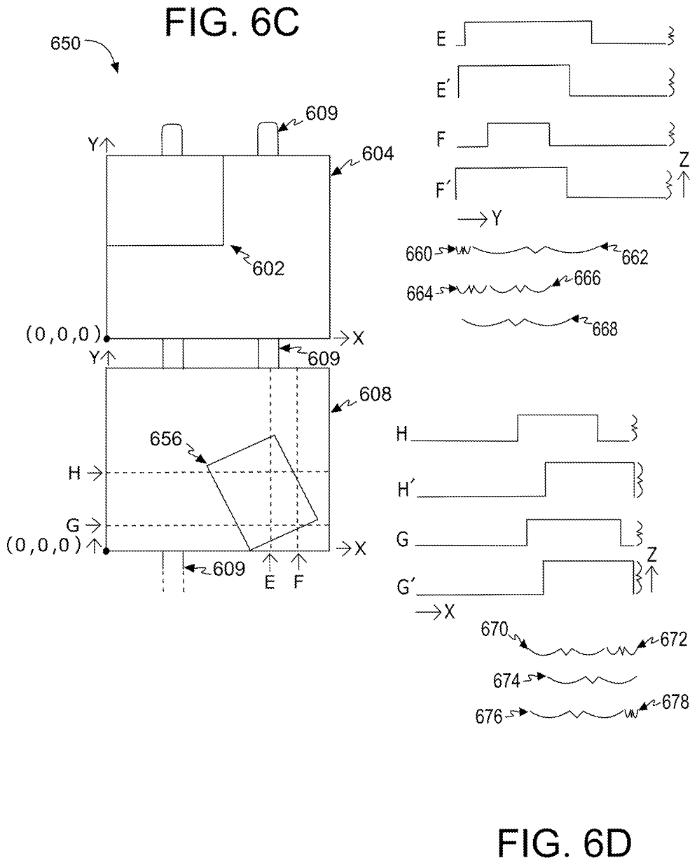

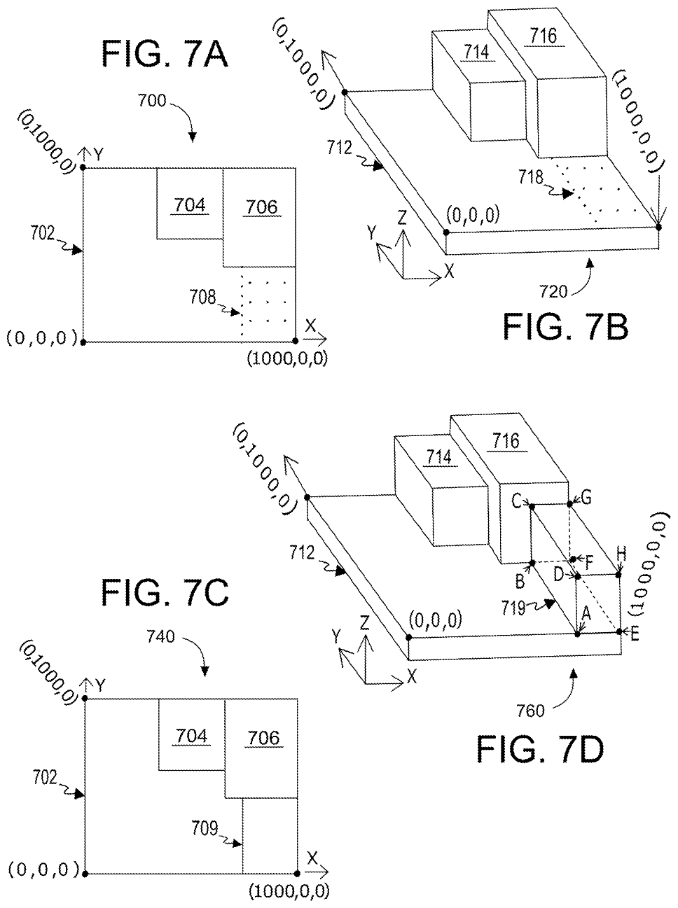

Once the order selector stacks the item(s) onto the appropriate handling unit, the item, the number of item(s), and the position and orientation of the stacked item(s) are scanned in step 538 and validated in step 540. These steps may be performed once the order selector completes the picking and stacking process or it may be performed continuously as the order selector picks and stacks the items. If at completion, the order selector may indicate that the picking and stacking has been completed such as by checking off the completion of the process on a touch sensitive display, through a verbal command, or through other types of indicators. In either case, a camera or other device mounted on the MHE, the virtual reality headset, or other device may view the size and orientation of the items stacked onto the appropriate handling unit. The stacked items should be a certain size, location and orientation on the handling unit. This optical recognition process is described in greater detail below with reference to FIGS. 6A-6D and 7A-7D. In addition, the stacked items may include certain labeling that can be optically read or other types of identifying information may be utilized to verify the item and quantity thereof. If the correct items are correctly stacked, the order selector may either be notified of this event or no notification is provided. Alternatively, if the order selector stacks incorrect items, an incorrect number of items, or stacks the items in an incorrect position or orientation, the order selector may be notified of this event in step 540. The order selector may be able to indicate that an insufficient number of items were available for stacking or that other issues have occurred such as a change in the size and shape of the item being picked (e.g., an item may be packaged differently and the item characteristics database of such items may not have been updated with the different packaging). In such a case, an exception has occurred and corrective action may be needed pursuant to the process described below with reference to FIG. 5C. For example, the manner of stacking the items on the handling unit may need to be recalculated, especially if other items are to be stacked on top of the insufficient number of items.

This process of steps 522-540 is repeated until all the items have been picked and stacked into the handling units. Upon completion of steps 522-540, a completed pick list is generated, such as described with reference to step 480 above, identifying all the items and quantities thereof stacked on each of the handling units.

FIG. 5C is a flow diagram 560 directed to processes for handling exceptions such as described above with reference to step 470 of FIG. 4. That is, flow diagram 560 is directed to handling exceptions which may occur during the picking processes such as the processes described with reference to 5B above, but which may necessitate repeating some of the processes described with reference to FIG. 5A above. In this description of the present embodiment, an exception may occur during the bin location and validation process of steps 526-528, during the picking and validation process of steps 534-536, or during the stacking, scanning and validation process of steps 538-540. Additional types of exceptions for handling may be utilized in alternative embodiments.

In step 562, it is determined whether an incorrect item has been picked. This can be identified by scanning the item being picked or being stacked onto the handling unit, such as by scanning the item or by scanning or other indication of the item being picked and stacked by the order selector. If it is an incorrect item, then processing continues to step 564, otherwise processing continues to step 566. In step 564, the order selector is informed that an incorrect item has been picked. This can include an audible signal of the improper picking of the item, possibly with a visual signal such as a flashing light illuminating the incorrect item, or an audible warning of the improper placement of the item(s) along with a visual display of what the correct item should look like. Such a visual display may be a display mounted on the MHE or on a headset worn by the order selector, or other alternative ways to signal the order selector of the incorrect item picking. Processing can then return to the steps invoking the handling exception to scan and verify the proper picking of the item.

In step 566, it is determined whether an item being picked is the correct item, but has changed in shape from what is known about that item in the item characteristics database used for generating the item selection list and the stacking instructions. If not, then processing continues to step 570, otherwise processing continues to step 568. In step 568, the item characteristics database may be updated with the new characteristics (e.g., height, length and width) of the item. These measurements may be made by the detection unit to update the item characteristics database. Then the remaining stacking of the handling unit may be modified to accommodate the changed characteristics of the item similar to the process described with reference to steps 508-510 above. Processing would then return to the step invoking the handling exception. In an alternative embodiment, the item may just be removed from the item selection list and the remaining stacking of the handling unit may be modified to accommodate the removal of the item from the handling unit.

In step 570, it is determined whether one or more items being stacked are improperly positioned or oriented on the handling unit. If not, then processing continues to step 574, otherwise processing continues to step 572. In step 572, the order selector is informed that the item(s) have been improperly positioned and/or oriented and instructions are provided on where the items should be positioned or oriented. This can include an audible signal of the improper placement of the item(s) along with a visual signal such as a flashing light illuminating the misplaced items(s), an audible warning of the improper placement of the item(s) along with a visual display of how the items should be stacked such as on a display mounted on the MHE or on a headset worn by the order selector, or other alternative ways to signal the order selector to correct the placement of the item(s). Processing can then return to the steps invoking the handling exception to scan and validate the proper stacking of the item(s) or allow an override by the order selector. In such a case, the placement of future picks may be recalculated to accommodate the mis-positioned item(s).

In step 574, it is determined whether there is a shortage or overage of items to be picked. This could be caused by a lack of items in inventory or even a lack of a bin holding the items for picking or, in the case of an overage, by human or machine error. If not, then processing continues to step 580, otherwise processing continues to step 576. In step 576, upon confirmation of a shortage of items to be picked, the remaining stacking of the handling unit may be modified or otherwise reconfigured to accommodate the changed characteristics of the item similar to the process described with reference to steps 508-510 above. Due to the shortage of items on the handling unit, the overall weight and ability for items to stack on top of the handling unit may affect the subsequent loading of the shipment including the handling unit. The change in weight of the handling unit may be compared to a predetermined threshold amount to determine whether the shipment needs to be modified to accommodate the changed weight or dimensions of the stacked handling unit. This shipment modification in step 578 can include changing the position of some handling unit in the shipment or shifting items not yet picked to the handling unit currently being picked. Upon completion of steps 576-578, processing can then return to the steps invoking the handling exception to scan and validate the proper stacking of the item(s).

In step 580, an exception may have occurred which requires human intervention or advanced artificial intelligence to determine. For example, the shortage of items may result in a need to reschedule shipments to accommodate the item shortages. At the same time, in such a case, the placement of future picks may be recalculated to accommodate the missing item(s) or the order selector may be instructed to take the partially loaded handling units to a holding area until the human intervention is completed and processing can continue. In alternative embodiments, other types of exceptions may be identified and added for processing by one of ordinary skill in the art.

FIGS. 6A-6D provide overhead view diagrams of item stacking on handling units including validation of the stacking in accordance with a first embodiment of the present disclosure. FIGS. 6A and 6C illustrate items being stacked on handling units for validation and FIGS. 6B and 6D illustrate lines of pixels utilized for verification of the item dimensions, position and orientation as compared to predicted values. For the present invention predicted refers to calculated expected values which may be performed prior to, concurrently with, or even after observed values. Predicted values calculated prior to observed values may be referred to herein as forecasted values. When items are picked from bins or provided by a conveyor or similar device for stacking, multiple such items may be picked as ordered and indicated on the item selection list. This set of the same item type picked or provided from a single bin or bin area and then stacked together, typically contiguously, on a handling unit for detection and verification is referred to herein as an item set. That is, a set of items may be multiple types of items selected from multiple bin areas whereas, as defined herein, an item set is one or more items picked and stacked together from a bin area of the same item type (e.g., SKU) without necessitating the movement of the MHE. Although a single item set may be picked and stacked from the same bin area as described herein, multiple items sets may also be picked and stacked concurrently from the same bin area without necessitating movement of the MHE. While the present embodiment is described with reference to picking, stacking, detecting and verifying a single item set at a time, multiple item sets may be picked, stacked, detected and verified concurrently. When an item set is picked and stacked in accordance with the item selection list, the item set may be picked and stacked individually or in groups or as a whole, depending on the size and weight of each individual item. As a result, the validation process described in this first embodiment may view the item set as a whole for validation purposes. If the items of an item set are stacked individually or in groups of items, each individual item or groups of items may be referred to herein as an item set.

FIG. 6A provides an overhead view 600 of a first item set 602 stacked on a first handling unit 604 for validation and an indication (e.g., a projected light on the indicated area) of where to stack a second item set 606 on a second handling unit 608. The first and second item sets may be comprised on the same or different items. In the present embodiment, each handling unit is a pallet loaded onto the forks 609 of a MHE. An overhead detection unit, such as a camera, mounted on an arm extended from the MHE, can detect the distance of a set of pixels across each handling unit. The overhead detection unit may be a depth camera that utilizes amplitude modulated continuous wave (AMCW) time-of-flight (ToF) principle to detect the distance from the detection unit to the handling unit and items stacked on the handling unit. The detection unit may cast modulated illumination in the near infrared spectrum onto the underlying handling units and items stacked on those handling units, then record an indirect measurement of the time it takes the near infrared illumination to travel back to the detection unit from the underlying handling units and stacked items. Alternative techniques and equipment may be utilized for the detection unit such as ultrasonic emitters and detectors. Although both handling units are shown concurrently, the detection unit may be moved back and forth above each handling unit for better illumination and detection of distance from the detection unit. From this illumination and detection, the distance of the handling units and stacked items from the detection unit may be calculated, which can be converted to a set of height (or depth) measurements for each pixel. Each such pixel has X, Y and Z coordinates with the X and Y coordinates illustrated on view 600 and the Z coordinate being the height of each pixel as observed by the detection unit mounted to the handling unit. In the present embodiment, the point of origin for each handling unit is shown as (0, 0, 0). There may be a million or more such pixels in a 1000 by 1000 grid, depending on the resolution desired, the size of the handling units, and the distance of the handling units from the detection unit. In the present embodiment, 10 pixels equals about 1 centimeter. The camera may be calibrated periodically in the X, Y and Z directions, such as by using markers at a known relative location such as on the MHE forks, the handling unit, the underlying floor, or even a drop down marker a known distance from the overhead detection unit.

As shown in the present embodiment, item set 602 on handling unit 604 is observed from the detection unit for verification of its dimensions as well as its position and orientation on the handling unit. As described with reference to FIG. 6B, item set 602 with dimensions of 40 cm wide by 30 cm long by 10 cm high is supposed to have been stacked on the upper left corner of upper handling unit 604.

In this embodiment, two lines of detected pixels at certain X values are shown as A and B and two lines of detected pixels at certain Y values are shown as C and D. This combination of observed lines of pixels is referred to herein as an observed map of the stacked handling unit. That is, a map is a representation of a stacked handling unit or a selected area of the handling unit (e.g., in or near an indication area). As shown in this embodiment, A may be all pixels at X=100 and B may be all pixels at X=300 out of 1000 pixels of length. In addition, C may be Y=900 and D may be Y=800 out of 1000 pixels of width. The heights or Z value of each pixel are also calculated using the detection unit. The results of this scanning and mapping of item set 602 stacked on handling unit 604, the observed mapping, is shown in FIG. 6B along with predicted values for the detected lines of pixels, referred to herein as a predicted map. In FIG. 6B, observed pixel lines A and B are virtually identical as are shown together. Similarly, C and D are virtually identical, as well as A′ and B′ as well as C′ and D′.

With reference to FIG. 6B, pixel lines A and B are at X=100 and X=300 from Y=0 to 1000 (from left to right). The Z coordinate is also shown. As shown, A and B are level, about at a Z=0 value, until reaching region 610 whereby the Z rises to a value 614 such as 10 centimeters from when Y=about 700 to 1000 or a distance about 30 centimeters. A and B can be compared to predicted values of A′ and B′ to verify that the item set scanned has the predicted dimensions in that direction. As also shown, C and D quickly rise to a Z value 614 of about 10 centimeters, remain at that height across region 612 for about 400 pixels or 40 centimeters, then drop to a level Z=0 value across the rest of the handling unit. C and D can be compared to predicted values of C′ and D′ to verify that the item set scanned has the predicted dimensions in that direction.

In summary, the item set has been observed to have dimensions of 40×30×10 centimeters, which matches the predicted dimensions according to the predicted map. In addition, the item set is positioned and oriented correctly, as the observed map of the stacked handling unit matches the predicted map. Some variation of the observed map from the predicted map may be allowed to avoid too many false negatives (false indications of an incorrect or placed item set). A predetermined threshold amount of variation may be allowed and may be modified based on several factors such as experience with the detection unit, the number of items previously stacked on the handling unit (which could increase variation as more items are stacked on top of each other), etc. An example of a mismatch in item set dimensions, position and orientation is illustrated with reference to FIGS. 6C and 6D below.

Many such lines of pixels may be utilized for making the determinations of item set dimensions, position and orientation. In addition, instead of comparing lines of pixels, whole groups of observed pixels may be processed three dimensionally as described below with reference to FIGS. 7A-7D. In addition, such comparisons of observed versus predicted map of the stacked handling unit may be performed continuously as the order picker is stacking the item set onto the handling unit. However, the system may not compare observed with predicted maps until the item set placed on the handling unit are stationary for a predetermined period of time or until the order picker indicates that the picking and stacking has completed.

FIG. 6C provides an overhead view of second item set 656 stacked on the second handling unit 608 for validation. Second item set 656 should be stacked in position 606 on handling unit 608 as indicated in FIG. 6A. As described above, in the present embodiment each handling unit is a pallet loaded onto the forks 609 of a MHE. An overhead detection unit, such as a camera, mounted on an arm extended from the MHE, can detect the distance of a set of pixels across each handling unit utilizing a detection unit such as a depth camera that utilizes AMCW ToF principle to detect the distance from the detection unit to the handling unit and items stacked on the handling unit. Although both handling units are shown concurrently, the detection unit may be moved back and forth above each handling unit for better illumination and detection of distance from the detection unit. From this illumination and detection, the distance of the handling units and items from the detection unit may be calculated, which can be converted to a set of height (or depth) measurements for each pixel. Each such pixel has X, Y and Z coordinates with the X and Y coordinates illustrated on view 650 and the Z coordinate being the height of each pixel as observed by the detection unit mounted to the handling unit. In the present embodiment, as described with reference to FIG. 6A, the point of origin for each handling unit is shown as (0, 0, 0). There may be a million or more such pixels in a 1000 by 1000 grid, depending on the resolution desired, the size of the handling units, and the distance of the handling units from the detection unit. In the present embodiment, 10 pixels equals about 1 centimeter. In addition, the camera may be calibrated periodically in the X, Y and Z directions, such as by using markers at a known relative location such as on the MHE forks, the handling unit, the underlying floor, or even a drop down marker from the overhead detection unit.

As shown in the present embodiment, item set 656 on handling unit 608 is observed from the detection unit for verification of its dimensions as well as its position and orientation on the handling unit. As will be described with reference to FIG. 6D, item set 656 with dimensions of 30 cm wide by 50 cm long by 20 cm high is supposed to have been stacked on the lower right corner of lower handling unit 608.

In this embodiment, two lines of detected pixels at certain X values are shown as E and F and two lines of detected pixels at certain Y values are shown as G and H. This combination of observed lines of pixels is referred to herein as an observed map of the stacked handling unit. As shown in this embodiment, E may be all pixels at X=800 and F may be all pixels at X=900 out of 1000 pixels of length. In addition, G may be Y=100 and H may be Y=400 out of 1000 pixels of width. The heights or Z value of each pixel are also calculated using the detection unit. The results of this scanning or mapping of item set 656 stacked on handling unit 608, the observed mapping, is shown in FIG. 6D along with predicted values for the detected lines of pixels, referred to herein as a predicted map. In FIG. 6B, observed map pixel lines E, F, G and H are shown alongside predicted map pixel lines E′, F′, G′ and H′.

With reference to FIG. 6D, pixel lines E and F are at X=800 and X=900 from Y=0 to 1000 (from bottom to top). The Z coordinate is also shown. As shown, E is level with Z=0 for about 5 cm in region 660, then rises about 15 cm across region 662, then levels back to Z=0 across the rest of the handling unit. This differs significantly from the predicted E′ where Z rises to 20 cm for about 50 cm in region 668 then drops to Z=0 for the rest of the handling unit. As shown, F is level for about 10 cm in region 664, then rises about 15 cm across region 666, then levels back to Z=0 across the rest of the handling unit. This differs significantly from the predicted F′ where Z rises to 20 cm for about 50 cm in region 668 then drops to Z=0 for the rest of the handling unit.

Also with reference to FIG. 6D, pixel lines G and H are at Y=100 and Y=400 from X=0 to 1000 (from left to right). The Z coordinate is also shown. As shown, G is level with Z=0 for about 65 cm, then rises about 15 cm across region 676, then levels back to Z=0 across region 678. This differs significantly from the predicted G′ where Z=0 for about 70 cm, then rises about 20 cm across region 674, then levels back to Z=0 at the edge of the handling unit. As shown, H is level with Z=0 for about 55 cm, then rises about 15 cm across region 670, then levels back to Z=0 across region 672 across the rest of the handling unit. This differs significantly from the predicted H′ where Z=0 for about 70 cm, then rises about 20 cm across region 674, then levels back to Z=0 at the edge of the handling unit.

In summary, item set 656 has been observed to have a height of 15 centimeters, which does not match the predicted dimensions according to the predicted map. The width and length are not fully determined due to the incorrect position and orientation of the item set as indicated by the variation between the observed and predicted maps. While some variation of the observed map from the predicted map may be allowed to avoid too many false negatives (false indications of an incorrect or placed item set), the amount of variation shown in FIGS. 6C and 6D exceeds any such reasonable variation. Of course, a threshold amount of variation may be allowed and may be modified based on several factors such as experience with the detection unit, the number of items previously stacked on the handling unit (which could increase variation as more items are stacked on top of each other), etc.

There may be several causes for this variation in height, position and orientation. The order picker may not have completed picking the desired item set and may not have completed positioning the item set on the handling unit, there may be a shortage of items, an incorrect item may have been picked and placed on the handling unit temporarily, etc. The order picker may be notified of this mismatch between observed and predicted maps, such as through an audible tone or message, a blinking light other visual signal, a displayed message, etc. The order picker can then ignore the notification and continue the picking and stacking of the item set until completion, indicate that there is a shortage of an item, etc.

FIGS. 7A-7D provide an overhead and perspective view diagrams of item stacking on handling units including validation of the stacking in accordance with a second embodiment of the present disclosure. In this second embodiment, a single handling unit is shown being stacked with items, although multiple handling units may be stacked concurrently. FIGS. 7A and 7C illustrate an overhead view, such as from a camera, of an item set being stacked on a handling unit for validation. FIGS. 7C and 7D illustrate an observed three-dimensional object representing an item set being stacked onto a handling unit for verification of the item set dimensions, position and orientation as compared to predicted values. As described above, when items are picked from bins or provided by conveyor, robot, AGV or similar device for stacking, multiple such items may be picked as ordered and indicated on the item selection list. This set of the same item type picked or provided from a single bin or bin area and then stacked together, typically contiguously, on a handling unit for detection and verification is referred to herein as an item set. That is, a set of items may be multiple types of items selected from multiple bin areas whereas, as defined herein, an item set is one or more items picked and stacked together from a bin area of the same item type (e.g., SKU) without necessitating the movement of the MHE. Although a single item set may be picked and stacked from the same bin area as described herein, multiple items sets may also be picked and stacked concurrently from the same bin area without necessitating movement of the METE. While the present embodiment is described with reference to picking, stacking, detecting and verifying a single item set at a time, multiple item sets may be picked, stacked, detected and verified concurrently. When an item set is picked and stacked in accordance with the item selection list, the item set may be picked and stacked individually or in groups or as a whole, depending on the size and weight of each individual item. As a result, the validation process described in this first embodiment may view the item set as a whole for validation purposes.

FIG. 7A provides an overhead view 700 of a handling unit 702 stacked with first and second item sets 704 and 706 with an indication area 708 (e.g., a projected light on the indicated area) of where to stack a third item set. The first and second item sets may be comprised on the same or different items. In the present embodiment, each handling unit is a pallet 702 that may be loaded onto the forks of an MHE such as shown in FIG. 3 above. In this embodiment, an overhead detection unit, such as a camera, mounted on an arm extended from the MHE, can detect the distance of a set of pixels across each handling unit. The overhead detection unit may be a depth camera that utilizes amplitude modulated continuous wave (AMCW) time-of-flight (ToF) principle to detect the distance from the detection unit to the handling unit and items stacked on the handling unit. The detection unit may cast modulated illumination in the near infrared spectrum onto the underlying handling units and items stacked on those handling units, then record an indirect measurement of the time it takes the near infrared illumination to travel back to the detection unit from the underlying handling units and stacked items. From this illumination and detection, the distance of the handling units and stacked items from the detection unit may be calculated, which can be converted to a set of height (or depth) measurements for each pixel. Alternative techniques and equipment may be utilized for the detection unit such as ultrasonic emitters and detectors. Each such pixel has X, Y and Z coordinates with the X and Y coordinates illustrated on view 700 and the Z coordinate being the height of each pixel as observed by the detection unit mounted to the MHE. In the present embodiment, the point of origin for each handling unit is shown as (0, 0, 0). There may be a million or more such pixels in a 1000 by 1000 grid, depending on the resolution desired, the size of the handling units, and the distance of the handling units from the detection unit. In the present embodiment, 10 pixels equals about 1 centimeter such that the handling unit is approximately 1 meter square in the present embodiment. The camera may be calibrated periodically in the X, Y and Z directions, such as by using markers at a known relative location such as on the METE forks, the handling unit, the underlying floor, or even a drop down marker a known distance from the overhead detection unit.

As shown in the present embodiment, item sets 704 and 706 on handling unit 702 are observed from the detection unit. This observation may be utilized to generate a three-dimensional object representation of the current handling unit and item sets such as shown in FIG. 7B. Such a three-dimensional object representation may be generated by utilizing techniques focusing on the top surface of the observed object, the edges and/or vertices of the observed object, or other techniques for identifying three dimensional objects. Such techniques may also vary by the type of item. For example, a top surface based technique may be utilized for items packaged in rectangular boxes with flat surfaces, or an edge based technique may be utilized for items packaged in unusual shapes such as bottles. In the present embodiment, second item set 706 is about 40 cm wide by 50 cm deep by 40 cm tall stacked in the upper right corner of the handling unit. Adjoining first item set 704 is about 30 cm wide by 40 cm deep by 30 cm tall. Also in the present embodiment, third item set 709 (as shown in FIG. 7C) to be stacked in indicated area 708 is predicted to be 30 cm wide by 50 cm long by 30 cm high as per the item selection list.

FIG. 7B provides a perspective three-dimensional object representation 720 of the overhead view shown in FIG. 7A. That is, the elements of FIG. 7B correspond to the elements of FIG. 7A, but are represented as an observed map of objects in digital memory for analysis as described herein. As illustrated in FIG. 7B, a handling unit 712 corresponding to handling unit 702 is stacked with first and second item sets 714 and 716 corresponding to item sets 704 and 706 with an indication area 718 (e.g., a projected light on the indicated area) corresponding to indication area 708 of where to stack a third item set. That is, in this embodiment, a compilation of handling unit 702, first item 704 and second item 706 are represented as three-dimensional objects 712, 714 and 716 as shown in FIG. 7B. In addition, the location for stacking the third item set is represented by indication area planar object 718. These objects may be represented utilizing the same coordinates and scale as shown in FIG. 7A, although other coordinates and scales may be utilized. Objects 712, 714, 716 and 718 may be represented utilizing a set of vertices for each corner of each object with edges (e.g., vectors) running between the vertices, utilizing a set of voxels (three-dimensional pixels), utilizing a set of pixels representing each plane of each object, etc. In the present embodiment, these objects are represented as a set of vertices and edges. This representation may be generated from the observed handling unit and item sets of FIG. 7A utilizing a detection unit that determines the width, depth and height as described above. Various types of tools and techniques may be utilized to generate these objects from the observations of the detection unit, many of which are known to those of ordinary skill in the art. These observed objects may then be represented and stored as an observed map of the current stacked pallet prior to stacking third item 709, which is to be represented as object 719. This observed map may match, within threshold constraints, a predicted map of these stacked item sets in accordance with the item selection list and stacking instructions. If not, such as due to jostling of the item sets when moving the MHE between bins, the order picker may be notified to correct the misalignment of the observed item sets.

FIG. 7C provides an overhead view 740 of handling unit 702 stacked with first and second item sets 704 and 706 with third item set 709 stacked onto previously shown indication area 708 (from FIG. 7A). In this example, item set 709 is stacked in the indicated area, which can be confirmed as described below with reference to FIG. 7D.

FIG. 7D provides a perspective three-dimensional object representation 760 of the overhead view shown in FIG. 7C. That is, the elements of FIG. 7D correspond to the elements of FIG. 7C, but are represented as a newly observed map of objects in digital memory for analysis as described herein. As illustrated in FIG. 7D, a handling unit 712 corresponding to handling unit 702 is stacked with first and second item sets 714, 716 and 719 corresponding to item sets 704, 706 and 709. That is, in this embodiment, a compilation of handling unit 702, first item 704, second item 706, and third item set 709 are represented as three-dimensional objects 712, 714, 716 and 719 as shown in FIG. 7D. These objects may be represented utilizing the same coordinates and scale as shown in FIG. 7C, although other coordinates and scales may be utilized. Objects 712, 714, 716 and 719 may be represented utilizing a set of vertices for each corner of each object with edges running between the vertices, utilizing a set of voxels (three-dimensional pixels), utilizing a set of pixels representing each plane of each object, etc. In the present embodiment, these objects are represented as a set of vertices and edges. This representation may be generated from the observed handling unit and item sets of FIG. 7A utilizing a detection unit that determines the width, depth and height as described above. Various types of tools and techniques may be utilized to generate these objects from the observations of the detection unit, many of which are known to those of ordinary skill in the art. Also, prior representations of the handling unit and item sets may be utilized to identify all objects but the newly stacked third item set. These observed objects may then be represented and stored as a current observed map of the stacked pallet including newly stacked third item set 719.

By comparing the current observed map 760 with the previously observed map 720, the dimensions and location of third item set 709 can be utilized to identify and generate an observed map of the third item set. That is, the dimensions of the third item set include any new volumetric items identified in current observed map 760 not included in previously observed map 720. Third item set 709 may be represented as object 719 with vertices A through G. In the present example, as determined by comparing the current observed map 760 with previously observed map 720, the coordinates of these vertices are A=(700, 0, 0), B=(700, 500, 0), C=(700, 500, 300), D=(700, 0, 300), E=(1000, 0, 0), F=(1000, 500, 0), G=(1000, 500, 300), and H=(1000, 0, 300). Appropriate edges (e.g., vectors) between the vertices may be utilized to fully identify and generate the observed map of the third item set.

The observed map of the third item set can then be compared to a predicted map of the third item set. That is, based on the item selection list, a predicted map of the third item set can be generated for comparison with the observed map of the third item set. This comparison may include comparing the dimensions of the observed map with the predicted map of the third item set to determine whether the dimensions match, within threshold constraints in accordance with the item selection list. This comparison may also include comparing the vertices locations of the of the observed map with the vertices locations of the predicted map of the third item set to determine whether the locations match, within threshold constraints in accordance with the item selection list and the stacking instructions. If not, then the order picker may be notified that the third item set has incorrect dimensions or improper position and/or orientation on the handling unit. The order picker can then make corrections, such as adding another item to the item set if there were an insufficient number of items picked and stacked, repositioning the item set, or the order picker may indicate that there are insufficient items available for including with the present order.

In summary, item set 709 as represented by object 719 has been observed to have dimensions of 30×50×30 centimeters, which matches the predicted dimensions according to the predicted map. In addition, item set 709 as represented by object 719 is positioned and oriented correctly, as the updated observed map of the stacked handling unit matches the predicted map. Some variation of the observed map from the predicted map may be allowed to avoid too many false negatives (false indications of an incorrect or placed item set). A threshold amount of variation may be allowed and may be modified based on several factors such as experience with the detection unit, the number of items previously stacked on the handling unit (which could increase variation as more items are stacked on top of each other), etc.

Such comparisons of observed map versus predicted map of the stacked item set or of the stacked handling unit may be performed continuously as the order picker or robot is stacking the item set onto the handling unit. However, the system may not compare observed with predicted maps until the item set placed on the handling unit are stationary for a predetermined period of time or until the order picker indicates that the picking and stacking has completed. Alternatively, the comparison of observed with predicted map may occur with the stacking of each item in the item set. In another alternative embodiment, a predicted map of the handling unit with the stacked third item set may be compared with observed map 760 to determine the dimensions, position and/or orientation of the stacked third item set. The predicted map of the stacked handling unit may be generated by adding a predicted map of the third item set to observed map 720.

FIG. 8 provides a more detailed flow diagram 800 of item stacking on handling units including validation of the stacking in which various embodiments may be implemented. This embodiment is described with reference to a MHE arriving at a bin for picking items in accordance with the item selection list, stacking the items onto a handling unit in accordance with the stacking instructions, and verifying the picking and stacking of the items. This process or portions thereof may be repeated for each item identified for picking on the item selection list. For example, portions of this process may be repeated for each item stacked during the stacking of a set of identical or similar items. In this embodiment, only a single handling unit is referenced, although multiple handling units may be concurrently stacked with item sets such as described above with reference to FIGS. 6A-6D. Alternative embodiments can include having the items delivered to the order selector by a conveyor, or other delivery mechanism, for stacking. As described above, this set of the same item type picked or provided from a single bin or bin area and then stacked together, typically contiguously, on a handling unit for detection and verification is referred to herein as an item set. That is, a set of items may be multiple types of items selected from multiple bin areas whereas, as defined herein, an item set is one or more items picked and stacked together from a bin area of the same item type (e.g., SKU) without necessitating the movement of the MHE. Although a single item set may be picked and stacked from the same bin area as described herein, multiple items sets may also be picked and stacked concurrently from the same bin area without necessitating movement of the MHE. While the present embodiment is described with reference to picking, stacking, detecting and verifying a single item set at a time, multiple item sets may be picked, stacked, detected and verified concurrently.

In a first step 804, the MHE arrives at a bin for item picking in accordance with the item selection list. In step 808, the bin location is verified such as by validating a verbally provided check sequence provided by the order selector (such as with utilizing a voice-directed application), scanning for a bin identifier, an RFID based confirmation, or simply a GPS location. In an alternative embodiment, which may be implemented in combination with the other validation options identified herein, a camera or other type of scanner may observe the picker and/or the picker's hands to determine whether the picker is picking from the correct bin. In another alternative embodiment, which may be implemented in combination with the other validation options identified herein, a camera or other type of scanner may observe the correct bin before and after the items are picked from that bin. The before and after observations may be compared to determine whether the picker picked from the correct bin and whether the correct number of items were picked. Further details regarding these alternative embodiments are described above with reference to FIG. 5B. In step 812, a sensing and projecting unit, including a detection unit such as a camera and a projection unit such as a light projector, is deployed over the handling unit for the next item set picking and stacking. In step 816, the detection unit senses the stacking of items sets on the currently stacked handling unit and a current observed map of the stacked handling unit is generated similar to the observed map generation described below with reference to step 844. Then in step 820, this current observed map is compared to a previously observed map of the stacked handling unit, such as from the stacking of a previous item set at a previous bin location, to determine whether the items may have jostled, moved or otherwise misplaced since the MHE moved to the current bin area. If so, then the order selector may be notified of this jostling and movement of the stacked items and instructed to correct the misplacement of the currently stacked item sets. In this comparison of the current observed map with previously observed map, a full raster based or three-dimensional object based analysis may not be needed. A simplified analysis of some edges and/or corners may be sufficient. This current observed map may be utilized as a base map for predicting and analyzing stacking of the item set as described below. In step 824, the order selector is notified of the item to be selected including the quantity thereof, which may occur audibly and/or visually such as through a display, an augmented reality visor or a headset. In step 828, a predicted map of the item set to be stacked onto the handling unit may be generated. In the case of a raster line approach such as described with reference to FIGS. 6A-6D above, certain predicted X and Y coordinate raster lines may be generated based on the predicted dimensions of the item set and the predicted stacking of that item set as per the stacking instruction for generating the predicted map of the item set on the handling unit. In the case of an object recognition approach such as described with reference to FIGS. 7A-7D above, a predicted map of an object representing the item set stacked onto the handling unit may be generated based on the predicted dimensions of the item set and the predicted stacking of that item set as per the stacking instructions. In step 832, an area on the handling unit is indicated for stacking the item set, such as by a projected light on the handling unit, through the augmented reality visor or headset, etc. This indication area may be identified by utilizing the predicted map, such as described in step 828. These steps may occur concurrently or in another sequence other than as described herein. In the case of an order picker having the items delivered by conveyor or other type of delivery, some of these steps may not be utilized.

In step 836, the order picker may scan or otherwise identify (e.g., check digit, barcode or RFID) an item from the current bin area for quick verification of the identity of that item. This can be accomplished with the use of a hand scanner, a camera or other visual detection unit if there is a barcode or other visual indicator on the packed item, an RFID detector, etc. This step is to help prevent the order picker from picking a similar but incorrect item, such as a particular flavor of otherwise identical toothpaste. If verified, the order picker may be notified of that verification or lack thereof such as by an audible or visual indication. Step 836 may be utilized more or less based on the likelihood of similar items stored nearby. Then in step 840, the order picker may obtain the items identified on the item selection list and verified in step 836 for stacking them onto the handling unit in the indicated area in accordance with the stacking instructions as indicated by a projected light on the handling unit, through the augmented reality visor or headset, etc. Generally items are stacked in a particular orientation (e.g., with a label on top or on a particular side, as instructed by the package, as instructed by the stacking instructions, etc.) in the indicated area. In step 844, the stacked handling unit with the picked and stacked item set is scanned by the detection unit or other sensing unit to generate an observed map of the item set stacked onto the handling unit. This step may occur continuously, upon the item set being stationary for a period of time, or upon an indication by the order picker that the picking and stacking of that item set has been completed. This scanning may include the whole handling unit or it may be limited to the general area of the indication area where the item set is to be stacked. If not generated above in step 828, a predicted map of the item set stacked onto the handling unit may now be generated.

In step 848, the observed map of the item set stacked onto the handling unit may be analyzed for identifying relevant information for use in verifying whether the correct item set as identified in the item selection list has been correctly stacked on the handling unit in accordance with the stacking instructions. This verification may allow a predetermined threshold amount of variation. In the case of a raster line approach such as described with reference to FIGS. 6A-6D above, certain X and Y coordinate raster lines may be identified that intersect the indication area for generating an observed map of the item set stacked onto the handling unit. All of the intersecting raster lines may be utilized, a selected portion of them may be utilized, and some raster lines outside the indication area may also be utilized to assist in verifying the dimensions of the item set. In the case of an object recognition approach such as described with reference to FIGS. 7A-7D above, the observed map of the item set stacked onto the handling unit may be compared with the observed map of step 816 above for generating an observed map of an object representing the item set stacked onto handling unit. This identification can include identifying the vertices and edges of the newly stacked item set.

In step 852, the observed map of the item set stacked onto the handling unit is compared to the predicted map of the item set stacked onto the handling unit. This can include verifying the position of the item set, and the orientation of the item set. This verification may compare raster lines, object vertices and edges, or other parameters that may be utilized for generating the observed map and the predicted map. This verification may allow a predetermined threshold amount of variation, which may be modified based on various factors such as the number of item sets already stacked onto the handling unit. In an alternative embodiment, separately calculated observed and predicted maps may be utilized for comparing item set dimensions versus the position and orientation of the item set. Then in step 856, the order picker may be notified of the verification results. The verification may occur only upon a negative verification so that action to correct may be taken by the order picker. In such a case, processing may then continue to processes for handling exceptions such as described above with reference to FIG. 5C. Otherwise, processing may return to step 804 above for processing the next item set for stacking into the handling unit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for managing automated guidance and validation of stacking items. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of managing automated guidance and validation of stacking items comprising:
generating a predicted map of an item set stacked onto a handling unit;
generating an observed map of the item set stacked onto the handling unit; and
comparing the predicted map with the observed map to verify the position and orientation of the item set stacked onto the handling unit.

2. The method of claim 1 further comprising verifying the dimensions of the item set.

3. The method of claim 2 wherein verifying the dimensions of the item set includes comparing the predicted map with the observed map to verify the dimensions of the item set.

4. The method of claim 1 wherein the observed map of the item set stacked onto the handling unit is a representation of an object.

5. The method of claim 3 wherein the object representation includes a set of vertices and edges.

6. The method of claim 1 further comprising providing an indication area where to stack the item set onto the handling unit; wherein the verification of the position and orientation of the item set is with reference to the indication area.

7. The method of claim 1 wherein the verification allows for a predetermined threshold amount of variation.

8. The method of claim 1 further comprising providing notification upon a negative verification of the position and orientation of the item set stacked onto the handling unit.

9. The method of claim 1 further comprising utilizing a detection unit to observe a picker picking the item set from a bin for stacking onto the handling unit; and verifying that the picker is picking the item set from a correct bin.

10. The method of claim 1 further comprising utilizing a detection unit to take images of a bin including the item set before and after the item set has been stacked onto the handling unit; and verifying that the item set was picked from the bin by comparing the before and after images.

11. A computer program product for managing automated guidance and validation of stacking items, the computer program product comprising a computer readable storage medium having program instructions embodied therewith, the program instructions processed by a processing circuit to cause the device to perform a method comprising:
generating a predicted map of an item set stacked onto a handling unit;
generating an observed map of the item set stacked onto the handling unit; and
comparing the predicted map with the observed map to verify the position and orientation of the item set stacked onto the handling unit.

12. The computer program product of claim 11 further comprising verifying the dimensions of the item set.

13. The computer program product of claim 12 wherein verifying the dimensions of the item set includes comparing the predicted map with the observed map to verify the dimensions of the item set.

14. The computer program product of claim 11 wherein the observed map of the item set stacked onto the handling unit is a representation of an object.

15. The computer program product of claim 13 wherein the object representation includes a set of vertices and edges.

16. The computer program product of claim 11 further comprising providing an indication area where to stack the item set onto the handling unit; wherein the verification of the position and orientation of the item set is with reference to the indication area.

17. The computer program product of claim 11 wherein the verification allows for a predetermined threshold amount of variation.

18. The computer program product of claim 11 further comprising providing notification upon a negative verification of the position and orientation of the item set stacked onto the handling unit.

19. The computer program product of claim 11 further comprising utilizing a detection unit to observe a picker picking the item set from a bin for stacking onto the handling unit; and verifying that the picker is picking the item set from a correct bin.

20. The computer program product of claim 11 further comprising utilizing a detection unit to take images of a bin including the item set before and after the item set has been stacked onto the handling unit; and verifying that the item set was picked from the bin by comparing the before and after images.

21. A data processing system for managing automated guidance and validation of stacking items, the data processing system comprising:
a processor; and
a memory storing program instructions which when processed by the processor perform the steps of:
generating a predicted map of an item set stacked onto a handling unit;
generating an observed map of the item set stacked onto the handling unit; and
comparing the predicted map with the observed map to verify the position and orientation of the item set stacked onto the handling unit.

22. The data processing system of claim 21 further comprising verifying the dimensions of the item set.

23. The data processing system of claim 22 wherein verifying the dimensions of the item set includes comparing the predicted map with the observed map to verify the dimensions of the item set.

24. The data processing system of claim 21 wherein the observed map of the item set stacked onto the handling unit is a representation of an object.

25. The data processing system of claim 23 wherein the object representation includes a set of vertices and edges.

26. The data processing system of claim 21 further comprising providing an indication area where to stack the item set onto the handling unit; wherein the verification of the position and orientation of the item set is with reference to the indication area.

27. The data processing system of claim 21 wherein the verification allows for a predetermined threshold amount of variation.

28. The data processing system of claim 21 further comprising providing notification upon a negative verification of the position and orientation of the item set stacked onto the handling unit.

29. The data processing system of claim 21 further comprising utilizing a detection unit to observe a picker picking the item set from a bin for stacking onto the handling unit; and verifying that the picker is picking the item set from a correct bin.

30. The data processing system of claim 21 further comprising utilizing a detection unit to take images of a bin including the item set before and after the item set has been stacked onto the handling unit; and verifying that the item set was picked from the bin by comparing the before and after images.
